(19) United States
(12) Patent Application Publication
(10) Pub. No.: US 2020/0002600 A1
(43) Pub. Date: Jan. 2, 2020

(54) METAL-CHELATE COMPLEX HYDROGEN SULFIDE SCAVENGERS

(71) Applicant: Baker Hughes, a GE company, LLC, Houston, TX (US)

(72) Inventors: Prasad Dhulipala, Katy, TX (US); Soma Chakraborty, Houston, TX (US); Jagrut Jani, Houston, TX (US); Scott E. Lehrer, The Woodlands, TX (US); Melanie Wyatt, Houston, TX (US)

(73) Assignee: Baker Hughes, a GE company, LLC, Houston, TX (US)

(21) Appl. No.: 16/022,429

(22) Filed: Jun. 28, 2018

(51) Int. Cl. C09K 8/54; C10G 17/09; E21B 43/34

(52) U.S. Cl. CPC C09K 8/54; C10G 17/09; C09K 2208/20; E21B 43/34; C12Y 108/05004

(57) ABSTRACT

This disclosure provides a method for scavenging hydrogen sulfide (H₂S) from a fluid containing H₂S and metal ions by introducing into the fluid at least one metal chelant in an amount effective to chelate metal ions in the fluid to form at least one metal-chelate complex; and removing at least a portion of the H₂S from the fluid with an effective amount of the at least one metal-chelate complex. The method may further comprise the step of introducing at least one enzyme having an ability to scavenge H₂S into the fluid in an amount effective to scavenge H₂S from the fluid, where the amount of the at least one metal-chelate complex is effective to influence the ability of the at least one enzyme to scavenge H₂S.

### BACKGROUND OF THE INVENTION

### Field of the Invention

The present invention relates to methods for scavenging hydrogen sulfide and metal ions from fluids containing them using metal-chelate complexes alone, and more particularly relates in another non-limiting embodiment to methods for scavenging hydrogen sulfide and metal ions from fluids containing them using metal-chelate complexes in combination with enzymes.

### Background of the Art

The subterranean reservoirs currently being developed have increased amounts of sulfur species within the produced hydrocarbon streams (oil and gas). The presence of sulfur species in hydrocarbon fluids and aqueous streams within oil production and refining systems is undesirable for various reasons. Hydrogen sulfide, bisulfide (HS⁻), and sulfide ions (S²⁻) are toxic gases that are heavier than air and are very corrosive to well and surface equipment. Moreover, hydrogen sulfide in various hydrocarbon or aqueous streams poses a safety hazard.

In addition, many upstream and downstream oilfield systems contain different heavy metal species, such as barium, cadmium, iron, lead, mercury, nickel, manganese, and zinc, that can also create an environmental risk if measures aren't taken to filter out or remove such metals from fluids used during the production and refining phases before their disposal.

It would thus be desirable in the art to develop more effective ways to scavenge heavy metals along with sulfur species, most notably hydrogen sulfide, from fluid streams within oil production and refining systems.

### SUMMARY OF THE INVENTION

In one aspect, there is disclosed a method for scavenging hydrogen sulfide (H₂S) from a fluid containing H₂S and metal ions by introducing into the fluid at least one metal chelant in an amount effective to chelate metal ions in the fluid to form at least one metal-chelate complex; and removing at least a portion of H₂S from the fluid with an effective amount of the at least one metal-chelate complex.

In yet another aspect, the method further comprises introduction to the fluid of at least one enzyme having an ability to scavenge H₂S in an amount effective to remove a portion of H₂S from the fluid; wherein the amount of the at least one metal-chelate complex is effective to improve the ability of the at least one enzyme to scavenge H₂S.

### BRIEF DESCRIPTION OF THE DRAWINGS

FIG. 1 is a graph comparing the effect of EDTA on SQR enzyme activity in removing of sulfides from sour water;

FIG. 2 is a graph comparing the effect of Citrate on SQR enzyme activity in removing of sulfides from sour water;

FIG. 3 is a graph comparing the effect of EDTA on SQR enzyme activity in removing sulfides from sour oil samples from an oil well;

FIG. 4 is a graph comparing the effect of EDTA on SQR enzyme activity in removing of sulfides from supply water from an oil well; and

FIG. 5 is a graph showing the concentration of H₂S in the headspace of an oil collected from a tank filled with oil that was treated with Tetrasodium EDTA and enzyme powder for 6 days.

### DETAILED DESCRIPTION

It has been discovered that the metal-chelate complexes that may be formed by combining certain metal chelating agents with metal ions found in hydrocarbon streams produced from oil and gas wells and related aqueous streams may be useful for scavenging hydrogen sulfide (H₂S) and other sulfur species from those same streams or other sour environments existing in oil production and oil refining systems. For purposes of this disclosure, the terms “scavenge/scavenging” are defined to mean “collect/collecting at least a portion from” or “remove/removing at least a portion from.”

It has also been discovered that these metal-chelate complexes may improve the ability of certain enzymes to scavenge H₂S and other sulfur species from hydrocarbon-based streams and aqueous-based streams containing these sulfur species in both upstream or downstream operations.

The metal-chelate complexes disclosed herein are useful in treating any hydrocarbon-based stream, aqueous-based stream, or mixture thereof in an oil production system or an oil refining system in which sulfur species, such as hydrogen sulfide (H₂S), bisulfide (HS⁻), and sulfide ions (S²⁻), are present. Examples of fluids in upstream and downstream operations that often contain sulfur species include, but are not limited to, refinery water, produced water, crude oil, downhole fluids, oilfield brines, and cooling water fluids. In addition, the enzymes disclosed herein have been shown to scavenge hydrogen sulfide from both the liquid and vapor phases of these exemplary hydrocarbon-based and/or aqueous-based fluids.

In one embodiment, the metal ions that are combined or reacted with the metal chelating agent to form the metal-chelate complex are naturally present in the hydrocarbon-based and/or aqueous-based fluids used in oil production and exploration operations described above. In an alternative embodiment, the metal ions may be added to the fluids. In either situation, when the metal chelating agent (i.e. a metal chelant) is introduced to the fluid containing the metal ions, the metal chelant binds to or reacts with the metal ion in situ to form an active metal-chelate complex.

Suitable metal chelating agents for creating the metal-chelate complex include, without limitation, ethylenediamine tetraacetic acid (EDTA), hydroxyethylenediamine triacetic acid (HEDTA), nitrilotriacetic acid (NTA), citrates, maleic acid, glutamic acid, tartaric acid, meso 2,3 dimercapto succinic acid, L-histidine, an alkali metal salt of any of these metal chelants, and combinations thereof. A single metal chelating agent may be used or a combination of metal chelating agents may be used.

The metal ions that are reacted with these metal chelating agents may include, but not necessarily be limited to, Hg⁺² (mercury), Cd⁺² (cadmium), Pb⁺² (lead), Zn⁺² (zinc), Cu⁺² (copper), Fe⁺² (iron), Ca⁺² (calcium), Mg⁺² (magnesium), Hg⁺³, Fe⁺³, Mn⁺² (manganese), Sr⁺² (strontium), Be⁺² (beryllium), Ba⁺² (barium), Bi⁺³ (bismuth), and combinations thereof.

The metal-chelate complexes formed by the in situ reaction of the metal ions and the metal chelants may combined with at least one enzyme to improve the scavenging of sulfur species from aqueous fluids, hydrocarbon fluids, and mixtures thereof.

Enzymes useful for scavenging sulfur species from such fluid streams are, for example, Sulfide Quinone Reductase (SQR), Cysteine Synthase, and combinations thereof. SQR may be generated by molecularly cloning SQR sequence from Acidithobacillus ferroxidans and the enzyme is produced in yeast expression system.

The metal-chelate complexes may also be introduced to the fluid or stream that is being treated with conventional hydrogen sulfide scavengers such as triazine.

The amount of the metal chelant in the fluid ranges from about 50 ppm independently to about 2,000 ppm, based on the total amount of fluid. The term “independently” in reference to a range means that any threshold may be used together with any other threshold to form a suitable alternative range.

The amount of at least one metal-chelate complex in the fluid ranges from about 50 ppm independently to about 2,000 ppm, based on the total amount of fluid.

The amount of enzyme introduced to the fluid ranges from about 100 ppm independently to about 20,000 ppm, based on the total amount of the fluid.

### EXAMPLES

The following examples are provided to illustrate the present invention. The examples are not intended to limit the scope of the present invention and they should not be so interpreted. Amounts are in weight parts or weight percentages unless otherwise indicated.

### Example 1

Forty percent solutions of Tetrasodium EDTA and citrate metal-chelate complexes were prepared to determine their effect on hydrogen sulfide scavenging performance of SQR enzyme on sour water samples and sour oil samples.

The efficacy of SQR enzyme was evaluated using sodium sulfide or H₂S gas as a sulfide source. Further, sour waters from refineries, sour produced water, and oil samples from wells were used for performance testing. Sulfide concentrations in liquid were measured by HACH methylene blue method (USEPA method 376.2) and head space H₂S was measured using Draeger tubes (ASTM D5705).

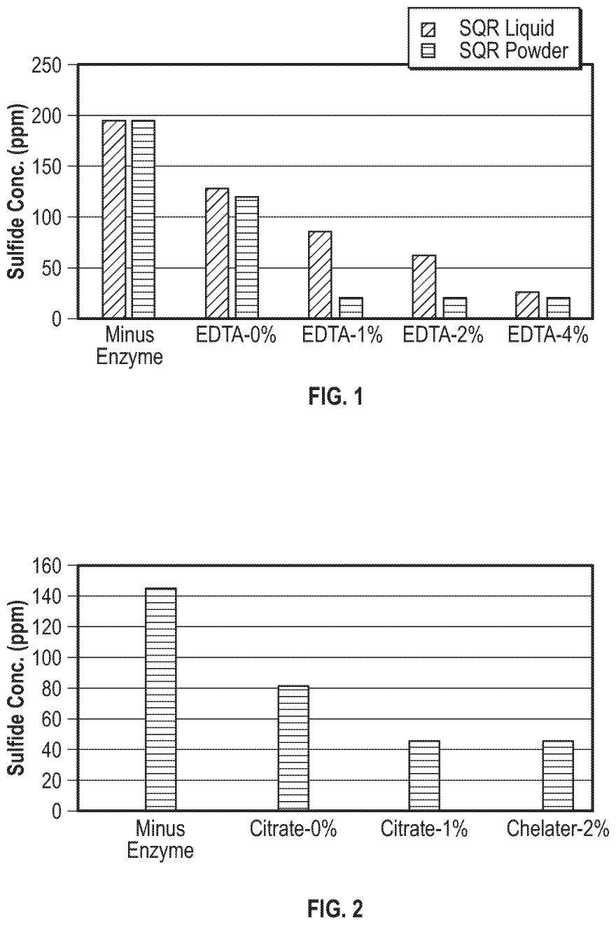

FIGS. 1 and 2 show that the effect of EDTA or citrate on SQR enzyme activity during treatment of sour water generated by dissolving Na₂S.9H₂O. The reaction contained 200 ppm of sulfide and 600 ppm of the SQR enzyme. The presence of Tetrasodium EDTA in the enzyme/sulfide reaction showed concentration dependent increase in scavenging activity of the enzyme. The presence of citrate increased the scavenging activity of the enzyme by 50%.

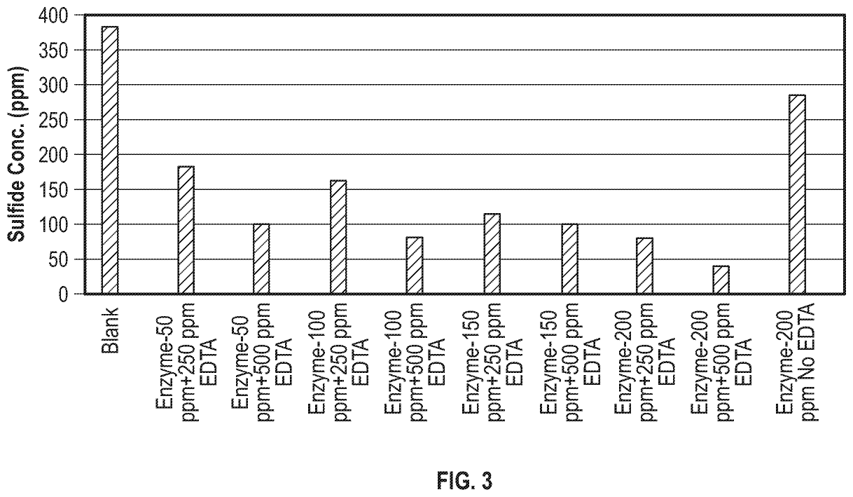

FIG. 3 displays the SQR enzyme scavenging activity in the presence of various amounts of Tetrasodium EDTA on sour oil samples. The Tetrasodium EDTA enhanced the scavenging activity of the enzyme by 50%.

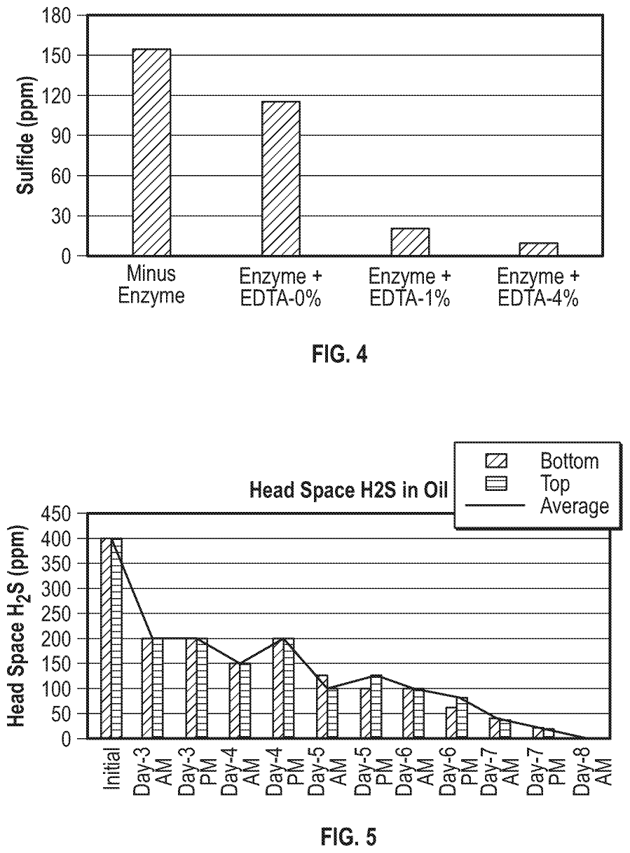

As shown in FIG. 4, the addition of EDTA to a sample of supply water from an oil well treated with the SQR enzyme enhanced the sulfide scavenging of the enzyme by 90%.

### Example 2

Field testing was also performed using enzyme formulation to treat oil at the oilfield. Test was conducted by by flowing 40 barrels of oil in to empty oil tank along with predetermined dosage of enzyme formulation containing 1:1 ratio of enzyme powder and Tetrasodium EDTA for 5 days. The initial hydrogen sulfide concentration of 400 ppm in headspace of the oil collected from source before entering the tank. The oil samples were collected from tank twice per day in the morning and evening from bottom and top the oil tank. Headspace hydrogen sulfide concentrations were measured using Draeger tube method. Oil and enzyme flow were stopped on 6^{th} day and the hydrogen sulfide levels were monitored for further two days.

The graph in FIG. 5 shows the average headspace H₂S values of oil samples collected from bottom and top of oil tank during 8 days of treatment. Results show complete reduction of sulfide in oil samples. Field test results showed continuous scavenging of sulfide ranging from 50 to 75% in headspace H₂S when oil and enzyme were reacted for 5 days during continuous flow. Once the oil and enzyme flow were stopped on day 6 and enzyme was allowed to react with oil in stationery phase, enzyme successfully mitigated 95% and 99.5% H₂S in 24 and 48 hours. Field trail of the enzyme formulations showed that the enzyme product can eliminate all or most of the sulfide from sour oil produced from oil wells.

In the foregoing specification, the invention has been described with reference to specific embodiments thereof, and has been described as effective in providing methods for removing hydrogen sulfide and/or metal ions from fluids containing them. However, it will be evident that various modifications and changes can be made thereto without departing from the broader scope of the invention as set forth in the appended claims. Accordingly, the specification is to be regarded in an illustrative rather than a restrictive sense. For example, aqueous and/or hydrocarbon fluids or stream, metal chelants, metal ions, enzymes, concentrations, and treatment conditions falling within the claimed parameters, but not specifically identified or tested, are expected to be within the scope of this invention.

The present invention may suitably comprise, consist or consist essentially of the elements disclosed and may be practiced in the absence of an element not disclosed. For instance, a method for scavenging hydrogen sulfide (H₂S) from a fluid containing H₂S and metal ions may comprise, consist essentially of, or consist of introducing into the fluid at least one metal chelant in an amount effective to chelate metal ions in the fluid to form at least one metal-chelate complex; and removing a portion of the H₂S from the fluid with an effective amount of the at least one metal-chelate complex.

Alternatively, a method for scavenging hydrogen sulfide (H₂S) from a fluid containing H₂S and metal ions may comprise, consist essentially of, or consist of introducing into the fluid at least one metal chelant in an amount effective to chelate metal ions in the fluid to form at least one metal-chelate complex; introducing at least one enzyme having an ability to scavenge H₂S into the fluid in an amount effective to remove a portion of the H₂S from the fluid, where the amount of the at least one metal-chelate complex is effective to improve the ability of the at least one enzyme to scavenge H₂S; and .removing a portion of the H₂S from the fluid with an effective amount of the at least one metal-chelate complex.

In another embodiment, a method for scavenging hydrogen sulfide (H₂S) from a fluid containing H₂S and metal ions may comprise, consist essentially of, or consist of introducing into the fluid or forming in the fluid at least one metal-chelate complex; introducing at least one enzyme having an ability to scavenge H₂S into the fluid in an amount effective to remove a portion of the H₂S from the fluid, where the amount of the at least one metal-chelate complex is effective to improve the ability of the at least one enzyme to scavenge H₂S; and removing a portion of the H₂S from the fluid with an effective amount of the at least one metal-chelate complex and an effective amount of the at least one enzyme.

The words “comprising” and “comprises” as used throughout the claims, are to be interpreted to mean “including but not limited to” and “includes but not limited to”, respectively.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

What is claimed is:

1. A method for scavenging hydrogen sulfide (H₂S) from a fluid containing H₂S and metal ions comprising:
introducing into the fluid at least one metal chelant in an amount effective to chelate metal ions in the fluid to form at least one metal-chelate complex; and
removing a portion of the H₂S from the fluid with an effective amount of the at least one metal-chelate complex.

2. The method of claim 1 further comprising introducing at least one enzyme having an ability to scavenge H₂S into the fluid in an amount effective to remove a portion of the H₂S from the fluid, where the amount of the at least one metal-chelate complex is effective to influence the ability of the at least one enzyme to scavenge H₂S.

3. The method of claim 2 where the at least one enzyme is selected from the group consisting of Sulfide Quinone Reductase (SQR), Cysteine Synthase, and combinations thereof.

4. The method of claim 1 where the metal ions in the fluid are selected from the group consisting of Hg⁺², Cd⁺², Pb⁺², Zn⁺², Cu⁺², Fe⁺², Ca⁺², Mg⁺², Hg⁺³, Fe⁺³, Mn⁺², Sr⁺², Be⁺², Ba⁺², Bi⁻³, and combinations thereof.

5. The method of claim 4 where the metal ions are incidentally present in the fluid and not intentionally added.

6. The method of claim 1 where at least one metal chelant is selected from the group consisting of ethylenediamine tetraacetic acid (EDTA), hydroxyethylenediamine triacetic acid (HEDTA), nitrilotriacetic acid (NTA), citrates, maleic acid, glutamic acid, tartaric acid, meso 2,3 dimercapto succinic acid, L-histidine, an alkali metal salt of any of these metal chelants, and combinations thereof.

7. The method of claim 1 where the fluid containing H₂S is selected from aqueous fluids, hydrocarbon fluids, and mixtures thereof.

8. The method of claim 1 where the fluid containing H₂S is selected from the group consisting of crude oil, downhole fluids, produced water, oilfield brines, cooling water fluids, and combinations thereof.

9. The method of claim 1 where the effective amount of the at least one metal chelant in the fluid ranges from about 50 ppm to about 2,000 ppm, based on the fluid.

10. The method of claim 2 where the effective amount of the at least one enzyme ranges from about 100 ppm to about 20,000 ppm, based on the fluid.

11. A method for scavenging hydrogen sulfide (H₂S) from a fluid containing H₂S and metal ions comprising:
introducing into the fluid at least one metal chelant in an amount effective to chelate metal ions in the fluid to form at least one metal-chelate complex, where the metal ions are selected from the group consisting of Hg⁺², Cd⁺², Pb⁺², Zn⁺², Cu⁺², Fe⁺², Ca⁺², Mg⁺², Hg⁺³, Fe⁺³, Mn⁺², Sr⁺², Be⁺², Ba⁺², Bi⁺³, and combinations thereof;
removing a portion of the H₂S from the fluid with an effective amount of the at least one metal-chelate complex; and
introducing at least one enzyme having an ability to scavenge H₂S into the fluid in an amount effective to remove a portion of the H₂S from the fluid, where the amount of the at least one metal-chelate complex is effective to improve the ability of the at least one enzyme to scavenge H₂S.

12. The method of claim 11 where the at least one enzyme is selected from the group consisting of Sulfide Quinone Reductase (SQR), Cysteine Synthase, and combinations thereof.

13. The method of claim 11 where at least one metal chelant is selected from the group consisting of ethylenediamine tetraacetic acid (EDTA), hydroxyethylenediamine triacetic acid (HEDTA), nitrilotriacetic acid (NTA), citrates, maleic acid, glutamic acid, tartaric acid, meso 2,3 dimercapto succinic acid, L-histidine, an alkali metal salt of any of these metal chelants, and combinations thereof.

14. The method of claim 11 where the effective amount of the at least one metal chelant in the fluid ranges from about 50 ppm to about 2,000 ppm, based on the fluid.

15. The method of claim 11 where the effective amount of the at least one enzyme ranges from about 100 ppm to about 20,000 ppm, based on the fluid.

16. A method for scavenging hydrogen sulfide (H₂S) from a fluid containing H₂S comprising:
introducing into the fluid or forming in the fluid at least one metal-chelate complex;
introducing at least one enzyme having an ability to scavenge H₂S into the fluid in an amount effective to remove a portion of the H₂S from the fluid, where the amount of the at least one metal-chelate complex is effective to improve the ability of the at least one enzyme to scavenge H₂S; and
removing a portion of the H₂S from the fluid with an effective amount of the at least one metal-chelate complex and an effective amount of the at least one enzyme.

17. The method of claim 16 where the at least one enzyme is selected from the group consisting of Sulfide Quinone Reductase (SQR), Cysteine Synthase, and combinations thereof

18. The method of claim 16 where at least one metal chelant is selected from the group consisting of ethylenediamine tetraacetic acid (EDTA), hydroxyethylenediamine triacetic acid (HEDTA), nitrilotriacetic acid (NTA), citrates, maleic acid, glutamic acid, tartaric acid, meso 2,3 dimercapto succinic acid, L-histidine, an alkali metal salt of any of these metal chelants, and combinations thereof.

19. The method of claim 16 where the effective amount of the at least one metal-chelate complex in the fluid ranges from about 50 ppm to about 2,000 ppm, based on the fluid.

20. The method of claim 17 where the effective amount of the at least one enzyme ranges from about 100 ppm to about 20,000 ppm, based on the fluid.
